(19) United States
(12) Patent Application Publication
(10) Pub. No.: US 2006/0012723 A1
(43) Pub. Date: Jan. 19, 2006

(54) Optical adjusting apparatus

(76) Inventor: Kun-Rong Chang, Miao-Li County (TW)

Correspondence Address: Hoffman, Warnick & D'Alessandro LLC, Three E-Comm Square, Albany, NY, 12207, US

(21) Appl. No.: 11/179,291

(22) Filed: Jul. 12, 2005

(30) Foreign Application Priority Data
Jul. 14, 2004 (TW) 093121056

(51) Int. Cl. H04N 5/74

(52) U.S. Cl. 348/785

(57) ABSTRACT

This invention provides an optical adjusting apparatus applied in a video and audio reproducing system to adjust the focal length of a lens within the video and audio reproducing system. The lens group includes a first lens set and a second lens set. The optical adjusting apparatus includes a controller and a moving device. The controller is used for generating an adjusting signal. The moving device is connected to the controller and the lens group. According to the adjusting signal, the moving device adjusts a position of the first lens set and a position of the second lens set so as to adjust the focal length and the image-forming focal point of the lens group.

### BACKGROUND OF THE INVENTION

1. Field of the Invention

The invention relates to an optical adjusting apparatus, and more particularly to an optical adjusting apparatus applied in a video and audio reproducing system.

2. Description of the Prior Art

Currently, because the focal length of a lens in a projection television is fixed (i.e. the focal length cannot be adjusted), the image size projected from the projection television is not adjustable. In other words, the conventional projection television doesn't have the function of adjusting the image size.

Referring to FIG. 1, FIG. 1 is a schematic diagram illustrating a conventional projection television 10 projecting an image 14. As shown in FIG. 1, there is always unstable noise around the edge of the image 14 projected from the projection television 10, so the size of the image 14 is usually enlarged to be bigger than the size of the screen 12. Afterward, the screen 12 is capable of displaying a stable image. In general, the projection television always enlarges the image 14 with 2% to 7% times the original size of the image 14, so as to effectively eliminate the noise around the edge of the image 14. As shown in FIG. 1, the area of oblique line represents the unstable noise around the edge of the image 14 projected from the projection television 10, wherein the unstable noise is eliminated by the screen 12. The screen 12 effectively eliminates the unstable noise around the edge of the image 14, so that the user can enjoy the stable image 14 through the screen 12.

However, the method for eliminating the noise around the edge of the image 14 by enlarging the image 14 reduces the visible area of the image 14. Although the image 14 is enlarged, the size of the screen 12 still maintains constant. Accordingly, the enlarged image 14 can only be displayed within the size of the screen 12, so the visible area of the image 14 is reduced and the overall brightness is also reduced, consequently the sharpness of the image 14 is lowered and the quality of the image 14 becomes unclear.

Referring to FIG. 2A and FIG. 2B, which are schematic diagrams illustrating the loss of the image brightness. FIG. 2A is a schematic diagram illustrating an image projected from a lens 20 of a projection television onto a screen 22. FIG. 2B is a schematic diagram illustrating an enlarged image projected from a lens 20 of a projection television onto a screen 22. As shown in FIG. 2B, when the enlarged image is projected from the lens 20 onto the screen 22, because the size of the enlarged image is larger than that of the screen 22, some of the enlarged image is blocked and reflected by the screen 22, and consequently the overall brightness is reduced and the sharpness of the image is lowered.

Therefore, one objective of the invention is to provide an optical adjusting apparatus for solving the above-mentioned problems.

### SUMMARY OF THE INVENTION

An objective of the invention is to provide an optical adjusting apparatus, which is applied in a video and audio reproducing system, for the user to adjust the focal length of the lens group within the video and audio reproducing system according to his/her own requirement so as to adjust the size of the image displayed by the video and audio reproducing system.

Another objective of the invention is to provide an optical adjusting apparatus, which is applied in a video and audio reproducing system, for the user to adjust the image-forming focal point of the lens group within the video and audio reproducing system according to his/her own requirement so as to enhance the image fidelity of the video and audio reproducing system.

The invention discloses an optical adjusting apparatus in a video and audio reproducing system. The optical adjusting apparatus is used for adjusting the focal length of a lens group in the video and audio reproducing system. The lens group includes a first lens set and a second lens set. The optical adjusting apparatus includes a controller and a moving device. The controller is used for generating an adjusting signal. The moving device is connected to the controller and the lens group. According to the adjusting signal, the moving device is used for adjusting a position of the first lens set and a position of the second lens set, so as to adjust the focal length and the image-forming focal point of the lens group.

According to the invention, the optical adjusting apparatus applied in a video and audio reproducing system utilizes the moving device to adjust the focal length and the image-forming focal point of the lens group. Therefore, the user can adjust the image size at will so as to increase the visible area of the image, reduce the loss of the brightness, and eventually enhance the image sharpness.

The advantage and spirit of the invention can be understood by the following recitations together with the appended drawings.

### BRIEF DESCRIPTION OF THE APPENDED DRAWINGS

FIG. 1 is a schematic diagram illustrating a conventional projection television projecting an image.

FIG. 2A is a schematic diagram illustrating an image projected from a lens of a projection television onto a screen.

FIG. 2B is a schematic diagram illustrating an enlarged image projected from a lens of a projection television onto a screen.

FIG. 3 is a system block diagram illustrating an optical adjusting apparatus according to a preferred embodiment of the invention.

FIG. 4 is a schematic diagram illustrating the optical adjusting apparatus shown in FIG. 3.

FIG. 5 is a schematic diagram illustrating the lens group of the optical adjusting apparatus shown in FIG. 3.

FIG. 6 is a schematic diagram illustrating an optical adjusting apparatus according to another preferred embodiment of the present invention.

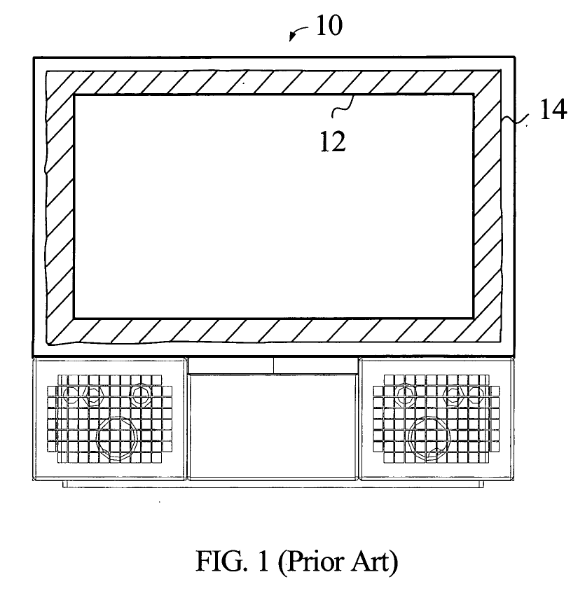

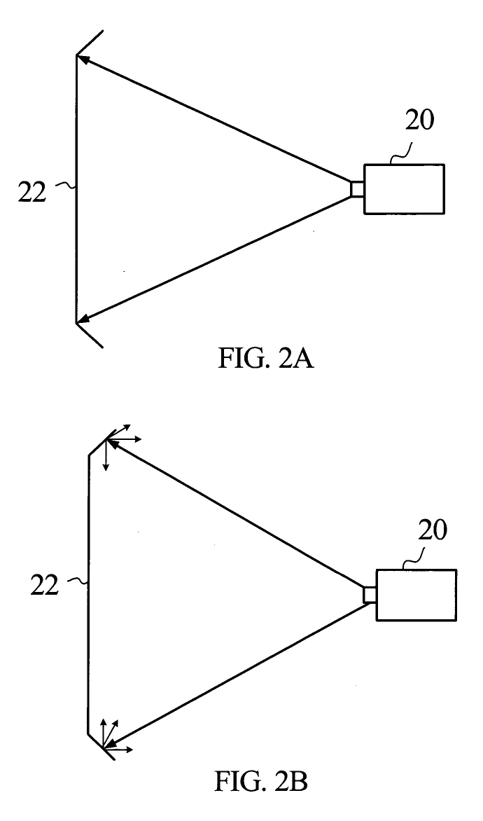

### DETAILED DESCRIPTION OF THE INVENTION

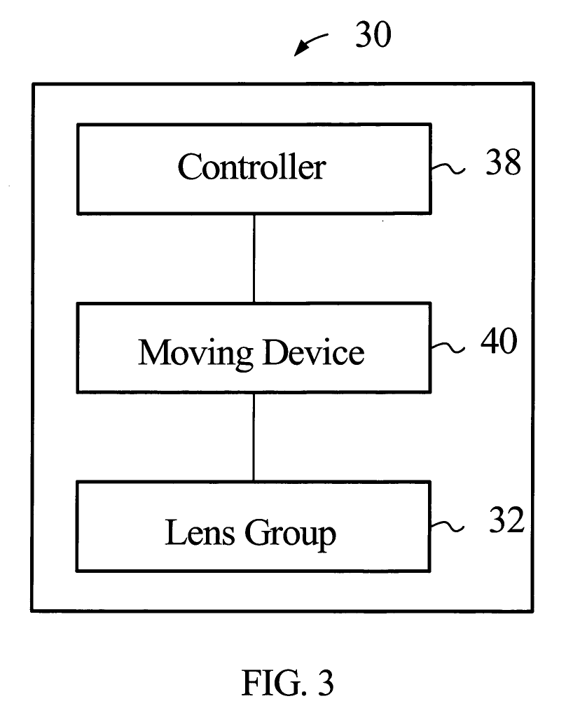

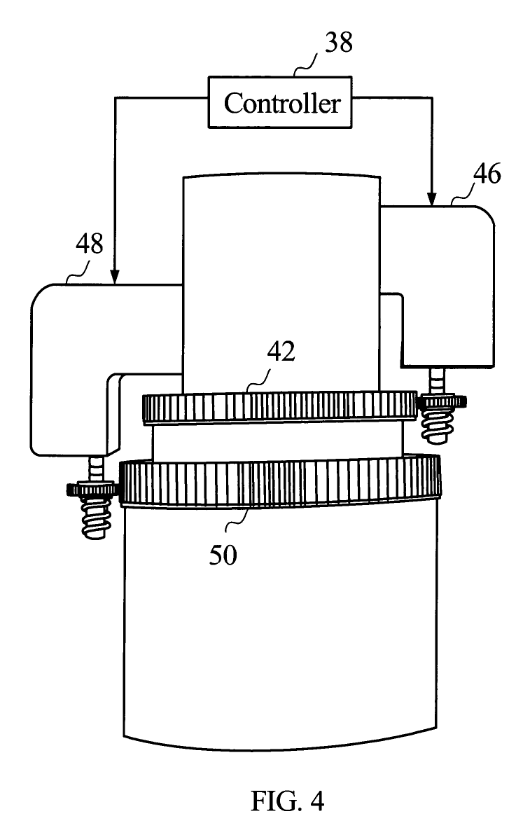

Referring to FIG. 3 and FIG. 4, FIG. 3 is a system block diagram illustrating an optical adjusting apparatus 30 according to a preferred embodiment of the invention. FIG. 4 is a schematic diagram illustrating the optical adjusting apparatus 30 shown in FIG. 3. According to the invention, the optical adjusting apparatus 30 applied in a video and audio reproducing system is used for adjusting the focal length and the image-forming focal point of a lens group 32 within the video and audio reproducing system. The lens group 32 includes a first lens set 34 and a second lens set 36. The optical adjusting apparatus 30 includes a controller 38 and a moving device 40.

The controller 38 is used for generating an adjusting signal. The moving device 40 is connected to the controller 38 and the lens group 32. According to the adjusting signal, the moving device 40 is used for adjusting a position of the first lens set 34 and a position of the second lens set 36, so as to adjust the focal length and the image-forming focal point of the lens group 32.

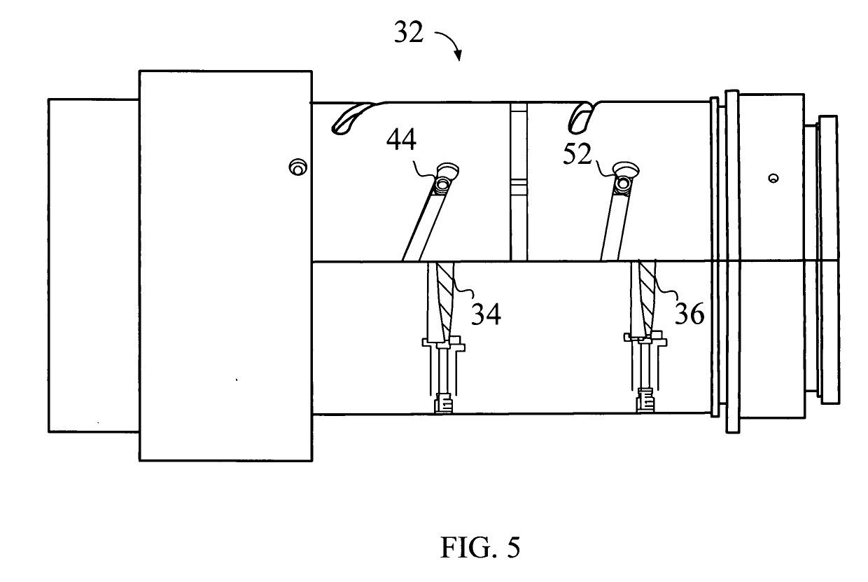

Referring to FIG. 4 and FIG. 5, FIG. 5 is a schematic diagram illustrating the lens group 32 of the optical adjusting apparatus 30 shown in FIG. 3. As shown in FIG. 4 and FIG. 5, the lens group 32 includes a first gear 42 and a first cam 44, wherein a first lens set 34 is fixed on the first cam 44. The moving device 40 includes a first motor 46 connected to the first lens set 34. The first gear 42 of the lens group 32 is connected to the first motor 46 and the first cam 44. According to the adjusting signal, the first motor 46 rotates the first gear 42 to further move the first cam 44. Afterward, the first lens set 34 will move together with the first cam 44, so as to adjust the position of the first lens set 34. Accordingly, the image size can be adjusted by adjusting the focal length of the lens group 32.

The moving device 40 further includes a second motor 48 connected to the second lens set 36. The lens group 32 further includes a second gear 50 and a second cam 52, wherein a second lens set 36 is fixed on the second cam 52. The second gear 50 is connected to the second motor 48 and the second cam 52. According to the adjusting signal, the second motor 48 rotates the second gear 50 to further move the second cam 52. Afterward, the second lens set 36 will move together with the second cam 52, so as to adjust the position of the second lens set 36. Accordingly, the image-forming focal point of the lens group 32 can be adjusted to enhance the image fidelity of the video and audio reproducing system.

According to the invention, the optical adjusting apparatus can control the first motor to move the first lens set by the moving device or control the second motor to move the second lens set by the moving device. The optical adjusting apparatus can also simultaneously control the first motor and the second motor to move the first lens set and the second lens set. Accordingly, the focal length and the image-forming focal point of the lens group can be adjusted.

In a preferred embodiment of the invention, the first motor and the second motor both are stepper motors with high stability and high precision. Therefore, since the invention utilizes the stepper motor to be the first motor and the second motor, the invention can precisely control the first motor and the second motor to move the first lens set and the second lens set. Because the first lens set and the second lens set both can be moved precisely, the focal length and the image-forming focal point of the lens group can be controlled precisely.

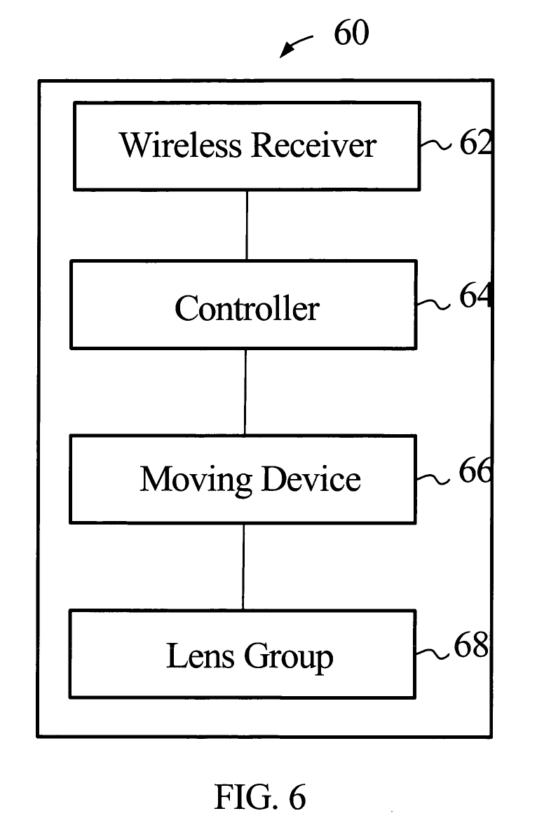

Referring to FIG. 6, FIG. 6 is a schematic diagram illustrating an optical adjusting apparatus 60 according to another preferred embodiment of the present invention. As shown in FIG. 6, the optical adjusting apparatus 60 includes a wireless receiver 62 connected to the controller 64. The wireless receiver 62 is used for receiving a wireless signal and generating a triggering signal. According to the triggering signal, the controller 64 generates an adjusting signal. After receiving the adjusting signal, the moving device 66 adjusts the focal length of the lens group 68. In another preferred embodiment, the wireless receiver is a signal receiver of a common remote control. When a user uses the remote control to generate a wireless signal, the signal receiver will generate a triggering signal and transmit the triggering signal to the controller. Afterward, according to the triggering signal, the controller generates the adjusting signal, and then, according to the adjusting signal, the motor rotates to further adjust the position of the lens set, so as to adjust the focal length and the image-forming focal point of the lens.

In a preferred embodiment, the video and audio reproducing system can be a projection television. The user can adjust the image size by changing the focal length of the lens group of the projection television. In another preferred embodiment, the video and audio reproducing system can be a projector. The user can also adjust the projected image size by adjusting the focal length of the lens.

According to the invention, the optical adjusting apparatus utilizes the controller to control the motor and further utilizes the gear connected to the motor to rotate the cam. Accordingly, the position of the lens fixed on the cam can be adjusted, and then the focal length of the lens group of the projection television can be also adjusted. Compared to the conventional projection television with fixed focal length, the user can adjust the focal length of the lens group to adjust the image size at will. The invention reduces the adjusted image size by adjusting the position of the lens, so as to increase the visible area of the image. Furthermore, because the image size is reduced, the loss of the brightness is also reduced. The reduced image is further adjusted by the second lens set so as to enhance the image fidelity. Therefore, the image displayed by the video and audio reproducing system will have better visible area, high brightness and high fidelity.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An optical adjusting apparatus in a video and audio reproducing system, the video and audio reproducing system comprising a lens group, the lens group comprising at least one lens set, the optical adjusting apparatus comprising:
a controller for generating an adjusting signal; and
a moving device connected to the controller and the lens group for adjusting a position of the lens set according to the adjusting signal, so as to adjust a focal length of the lens group for adjusting an image size projected from the lens group.

2. The optical adjusting apparatus of claim 1, wherein the moving device comprises a first motor connected to the lens set, and the first motor moves the lens set according to the adjusting signal so as to adjust the position of the lens set.

3. The optical adjusting apparatus of claim 2, wherein the lens group further comprises a first gear and a first cam, and the lens set is fixed on the first cam while the first gear is connected to the first motor and the first cam, the first motor rotating the first gear to further move the first cam to adjust the focal length of the lens group.

4. The optical adjusting apparatus of claim 3, wherein the first motor is a stepper motor.

5. The optical adjusting apparatus of claim 1, wherein the optical adjusting apparatus further comprises a wireless receiver connected to the controller for receiving a wireless signal and generating a triggering signal, wherein the controller generates the adjusting signal according to the triggering signal.

6. The optical adjusting apparatus of claim 1, wherein the moving device adjusts a position of the lens set so as to adjust the image-forming focal length of the lens group and to enhance the image fidelity of the video and audio reproducing system.

7. The optical adjusting apparatus of claim 1, wherein the video and audio reproducing system is a projection television.

8. The optical adjusting apparatus of claim 1, wherein the video and audio reproducing system is a projector.

9. An optical adjusting apparatus in a video and audio reproducing system, the video and audio reproducing system comprising a lens group, the lens group comprising at least one lens set, the optical adjusting apparatus comprising:
a controller for generating an adjusting signal; and
a moving device connected to the controller and the lens group for adjusting a position of the lens set according to the adjusting signal so as to adjust an image-forming focal point of the lens group and to enhance the image fidelity of the video and audio reproducing system.

10. The optical adjusting apparatus of claim 9, wherein the moving device further comprises a second motor connected to the lens set, and the second motor moves the lens set according to the adjusting signal, so as to adjust the position of the lens set.

11. The optical adjusting apparatus of claim 10, wherein the lens group further comprises a second gear and a second cam, and the lens set is fixed on the second cam while the second gear wheel is connected to the second motor, wherein the second motor rotates the second gear to further move the second cam to adjust the image-forming focal point of the lens group.

12. The optical adjusting apparatus of claim 11, wherein the second motor is a stepper motor.

13. The optical adjusting apparatus of claim 9, wherein the optical adjusted apparatus further comprises a wireless receiver connected to the controller for receiving a wireless signal and generating a triggering signal, wherein the controller generates the adjusting signal according to the triggering signal.

14. The optical adjusting apparatus of claim 9, wherein the video and audio reproducing system is a projection television.

15. The optical adjusting apparatus of claim 9, wherein the video and audio reproducing system is a projector.
